(19) United States
(12) Patent Application Publication
(10) Pub. No.: US 2012/0006917 A1
(43) Pub. Date: Jan. 12, 2012

(54) Water jet sweeper

(76) Inventor: Douglas Carr, Long Beach, CA (US)

(21) Appl. No.: 13/135,094

(22) Filed: Jun. 24, 2011

Related U.S. Application Data
(60) Provisional application No. 61/399,114, filed on Jul. 7, 2010.

(51) Int. Cl. B05B 1/14

(52) U.S. Cl. 239/754

(57) ABSTRACT

A water stream ground sweeping assembly includes a generally S-shaped tubular wand provided with an outlet nozzle at one end and connected at the other en across a control valve to a flexible water conveying hose with the length and the convolutions of the wand being selected to align the control valve with the suspended palm of an erect person. The arcs of the S-convolutions are further selected so that the nozzle raised above ground by a proximately located support post is pointing generally horizontally when the valve is grasped by the suspended palm. When, however, the palm of the person is raised the resulting increased weight of the unsupported hose increment unloads the post contact to create the perception of an impending loss of control in the palm, thus limiting the incidents of ground eroding nozzle alignments.

### REFERENCE TO RELATED APPLICATIONS

This application obtains the benefit of the earlier filing date of Provisional Patent Application No. 61/399,114 filed on Jul. 7, 2010.

### BACKGROUND OF THE INVENTION

1. Field of the Invention

The present invention relates to water stream directing mechanisms and more particularly to manually directed structures for deploying the jet of a debris sweeping water stream adjacent the surface that is being swept while also retaining full manipulative convenience over the selection of its angle of incidence and also its horizontal direction.

2. Description of the Prior Art

High pressure, narrowly focused and precisely directed water streams have been widely used to wash various surfaces and also as sweeping mechanisms to remove the loosened debris and dirt therefrom, with the usefulness of this cleaning process now even further enhanced by various augmentation mechanisms that increase its pressure. Simply, a garden hose with a well shaped, controllable nozzle at its end is now a virtually universal cleaning and sweeping device and the primary development focus is currently directed at increasing its flow rate and pressure.

A well focused, high pressure stream, however, is always associated with a reactive force and the task of controlling this force is both difficult and tiring, particularly when the slope angles of the cleaned surface, the amount of debris accumulated and the distances that it needs to be moved all demand long intervals of crouched or leaning body postures. One will appreciate that large quantities of debris, for example, are best moved along a surface by a low incidence, high pressure streams, thus demanding that the nozzle be held close to the ground while emitting high volumes of water. Of course, persistent retention of these geometric alignments of a high flow rate nozzle is extremely tiring and various support structures have been devised in the past which in one way or another assist in the task. These persisting postures become even more exacerbated during the course of thorough cleaning of variously configured tight spaces.

Amongst these prior art teachings are those that support the spray end on a rolling platform, as for example the spray mechanisms described in U.S. Pat. Nos. 6,045,064 to Abraham; 4,083,495 to Sharp; 2,638,730 to Davidson; and 2,607,622 to Doepke that are each combined with a distributed or fanned out spray pattern outlet that effectively distributes the reaction force. Moreover, while suitable for the purposes intended, each of the foregoing teachings is clearly directed to a very specific spray pattern and are therefore functionally limited to very small directional changes in the course of their use.

Those prior art devices that deploy the spray head directly on the ground surface, as exemplified in the teachings of US patents 5,477,583 to Deloe; 4,982,896 to Crow; and 2,289,889 to Stick et al., while also suitable for the purposes intended, lack the structural configuration and geometric range to allow for protracted directional alignments of the stream within the confines of human anatomy. Simply, effective sweeping requires constant adjustment of the low incidence, high pressure stream and the tiring retention of the high pressure head at these constantly varying alignments needs to be minimized by geometric selections that conform with the human anatomy, a focus not fully addressed in the prior art.

In consequence, little attention has been devoted to the manipulative task of debris sweeping of large surfaces by a high pressure stream and few devices are available that fully simplify this task. A high pressure, focused stream directing structure that conveniently adapts to the human skeletal geometry is therefore extensively desired and it is one such a structure that is disclosed herein.

### SUMMARY OF THE INVENTION

Accordingly, it is the general purpose and object of the present invention to provide a spray head deployment structure that is conformed to be manipulated by a person in an upright position to direct a focused stream in variously selected directions along a ground surface.

Further objects of the invention are to provide a support structure for a high pressure nozzle in which the geometry of the structure and that of the person using same are utilized to increase the contact pressure thereof against the ground.

Yet additional objects of the invention are to provide an extension wand for conveying a high pressure water flow through a nozzle deployed adjacent a ground surface convolved to increase the supporting contact thereof.

Briefly, these and other objects are accomplished within the present invention by providing a water stream dispensing extension in the form of a tubular wand provided with a generally arcuate handle extending from its upper end and a water stream dispensing nozzle proximate its lower end supported on a ground engaging pivot post. The free end of the arcuate handle is conformed for engagement to the outlet end of a garden hose with the flow through the handle into the wand then controlled by a lever aligned for manually effected pivotal displacement adjacent the handle.

Preferably the wand length, the arcuate dimension of the handle, the relative nozzle inclination and the pivot post are all selected to comfortably deploy the nozzle adjacent the ground easily turned along various azimuths and elevations with the forces transferred through the pivot post contact against the ground surface that is to be swept by the stream emitted from the nozzle then opposing all the reactive forces. Thus the selection of angles and dimensions is such that with the handle comfortably grasped by the user and the lever manually articulated to initiate the flow the resulting increased wand weight and the nozzle reaction forces are all opposed by the pivot post contact against the ground. By selecting a wand length of about 3 feet, with the handle then held by a person of an average height, all these geometric advantages are conveniently obtained, easing the tiring task of protracted water stream sweeping of large areas.

Those skilled in the art will appreciate that the task of sweeping a large surface area is a formidable, time consuming task that is best achieved with the aid of fairly robust water jets. These, however, invariably generate a substantial opposing reaction forces that need to be closely controlled as the efficacy of the cleaning depends greatly on the accuracy with which this highly focused and highly erosive water stream is aimed. The user engaged in such an endeavor will be quickly exhausted unless the stream forces are conveniently opposed by the geometry of the nozzle supporting post that also provides the desired weight offsets that reduce the moment resisted at the user's arm.

In particular, the selection of a generally S-shaped wand of a length that is somewhat greater than the typical distance between the hand of the user and the surface that is to be cleaned a wand inclination is effected where the wand weight, including that of the water volume contained, adds to the contact force at the supporting post end while also countering the stream force moment. Thus the nozzle is conveniently aligned adjacent the ground surface that is being cleaned in a manner where only small arm or hand manipulations are needed to control the stream direction.

In this manner an inexpensively produced and convolved tubular segment provided with conventionally available hose fittings at both ends can be conveniently inserted between the end of a garden hose and a commercially obtainable nozzle assembly to form a self supported sweeper structure that opposes the nozzle stream. A similarly conventionally available valve at the hose end can be also included in the assembly, modified to include an extended control lever to resolve all the burdens of protracted handling of a sweeper that entails the use of a focused, high volume and therefore vigorous water stream.

### BRIEF DESCRIPTION OF THE DRAWINGS

FIG. 1 is a perspective illustration of the inventive water stream sweeping assembly deployed in its preferred mode of use;

FIG. 2 is a diagrammatic illustration of the inventive water stream sweeping assembly in the course of its use, illustrating the several force balances effected therein;

FIG. 3 is a further perspective illustration, separated by parts, of the inventive water stream sweeping assembly conformed for varied alignment articulations thereof according to the vertical stream direction and azimuth desired;

FIGS. 4a and 4b are each a perspective detail view, in partial section, illustrating the several alternatives of the water flow control valve provided with an extended lever for use with the present invention; and

FIG. 5 is a sectional view taken along line 5-5 of FIG. 1, illustrating the engagement of telescoping parts of the inventive water stream sweeping assembly.

### DESCRIPTION OF THE PREFERRED EMBODIMENT

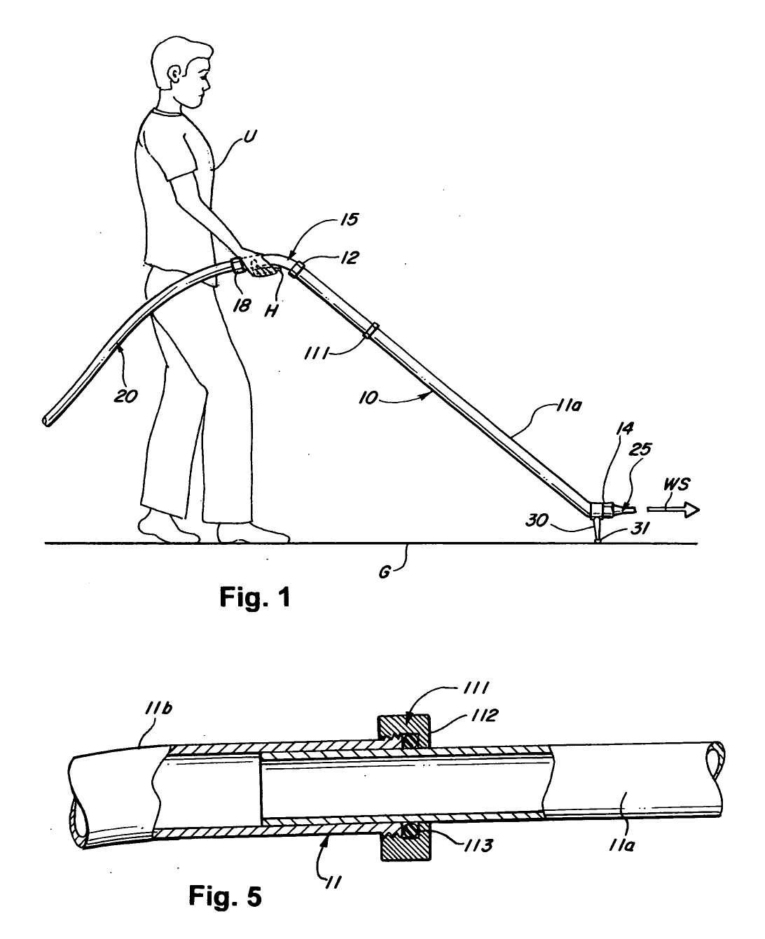

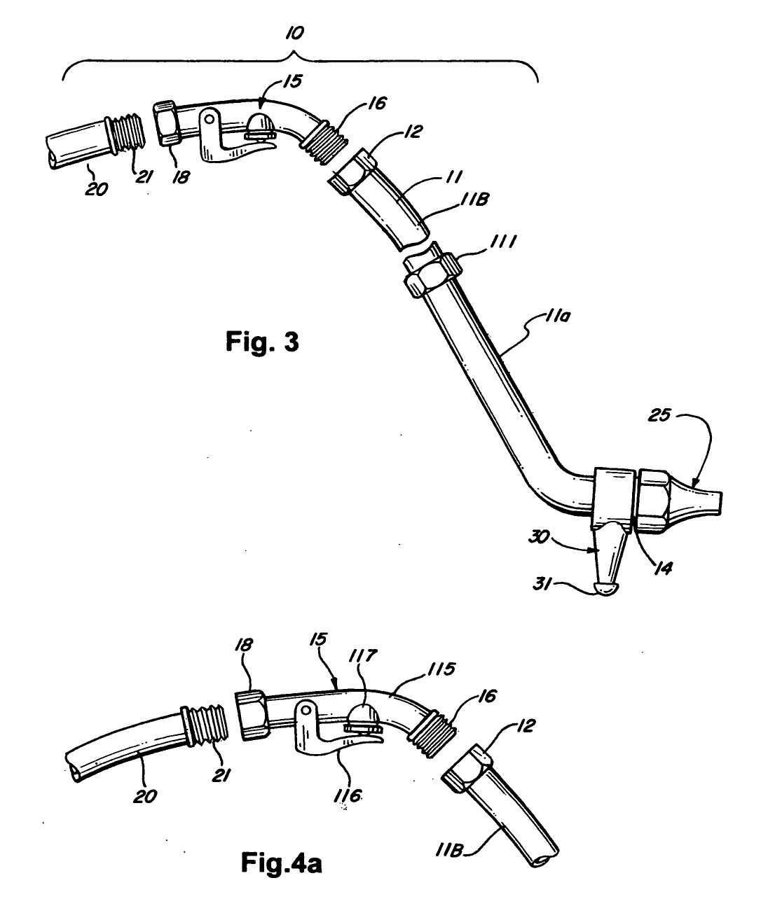

As shown in FIGS. 1-3 the inventive water stream sweeping assembly generally designated by the numeral 10 includes an elongate tubular element or wand 11 in the form of a hollow tube generally convolved longitudinally into an S-shaped form and provided with a female threaded fitting 12 at one end and a male threaded fitting 14 at the other end. Preferably, the female fitting 12 is conformed to receive a threaded male outlet end 16 of a valve assembly 15 which at the other end 18 connects to the end 21 of a garden hose 20 while a conventional focused stream nozzle 25 is mounted on the male threaded fitting 14 at the other end of the wand.

A short, generally tapered, support post 30 is fixed to the wand 11 adjacent the end fitting 14, extending generally orthogonally to the exterior of the local wand convolving curvature to form a supporting contact at its small free end 31 with the ground surface G. Preferably, the wand length, the post height, its relative inclination, the axial dimension of the nozzle 25 and the length of the wand that extends beyond the post towards the nozzle are all selected to unload the point contact against the ground G once the valve assembly 15 is raised to a level at which the water stream WS emitted from the nozzle 25 begins eroding the ground surface G. Simply, the geometric configuration of the wand and its support is such that once the wand is tilted forward to tilt the nozzle to an angular alignment that provides little sweeping benefit the reaction force opposed by the post contact with the ground is substantially lost with this loss then immediately perceived by the user U manually grasping the valve assembly 15.

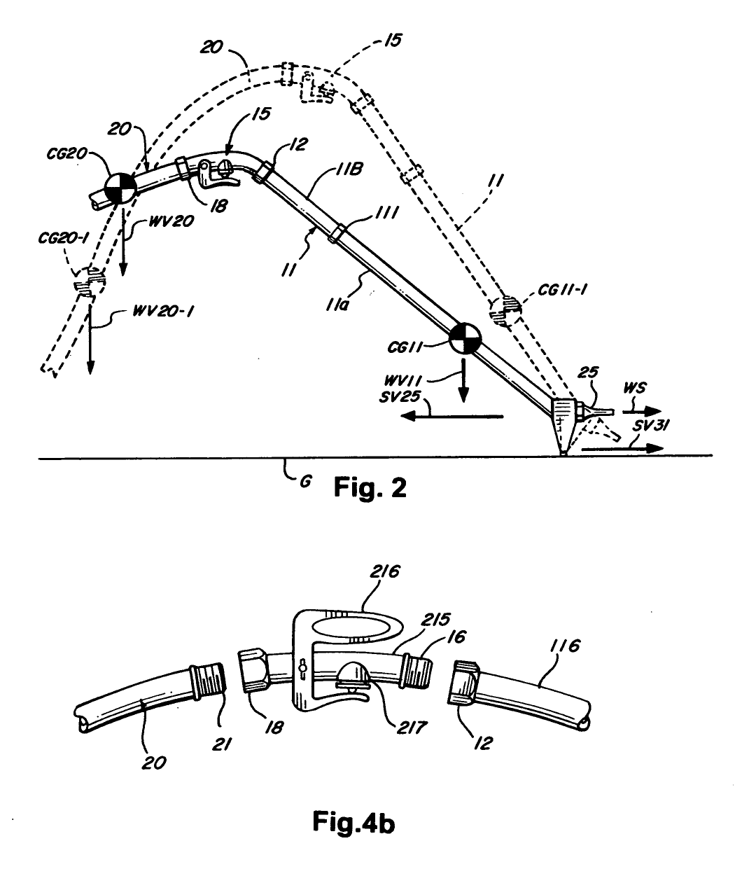

By particular reference to FIG. 2, those skilled in the art will appreciate that the weight of the wand 11, including the water therein, will act along a vertical weight vector WV 11 from its center of gravity CG11 that is partially balanced about the valve assembly 15 by a similar weight vector WV20 from the center of gravity CG20 of the unsupported portion of hose 20. The net vertical force differential is then taken up by a vertical force vector FV31 between the ground G and the end 31 of post 30.

A similar balancing of forces and moments is also obtained in the horizontal plane wherein the nozzle stream reaction vector SV 25 is opposed by the shear or friction force vector SV31 at the contact of post 30 with the ground G. The user U, therefore, senses little or no net moment in the palm of his or her hand H while grasping the valve assembly 15 within the useful range of wand alignments, but will begin to sense increasing moments when ground eroding angles are reached. At the other end the stress of a prolonged stooped posture limits useless nozzle angles above the horizontal plane.

Those skilled in the art will appreciate that the geometric inclination and the volumetric content of the wand 11 effectively counterbalances the weight of the unsupported portion of hose 20 about the valve assembly 15 where it is grasped, with a resulting increasing rearward bias as the hose 20 is lifted. By particular reference to FIG. 4a one form of the valve assembly 15 may include a generally arcuate valve body 115 threadably engaged at the ends thereof to provide a conveniently grasped exterior spanning between the threaded end fittings earlier described by reference to numerals 12 and 21. It is within this concave arc interior that a similarly arched pivoted handle 116 is deployed to articulate a conventional spring loaded valve control mechanism 117.

Like numbered parts functioning in a like manner to that earlier set out, the valve body 115 extends between its threaded end fittings 16 and 18 such that the concave, or interior, portion of its arc and the pivoted handle 116 rest comfortably within the user's hand H when the user is standing generally erect. By selecting the length geometry of wand 11 this same comfortably erect posture results in a generally horizontal alignment of the water stream WS emitted from the nozzle which is then unloaded to unload the pivoted handle 116, and thus shut off the water stream, once the valve assembly is lifted excessively to result in an eroding water stream alignment.

Alternatively, as illustrated in FIG. 4b, a cylindrical valve body 215 between the end fittings 16 and 18 is provided with yet another arcuate handle 216 deployed directly from a conventional spring biased valve mechanism 217 to form a suspending structure for the valve assembly 15. The user U then grasps the handle 216 to effect the desired directional controls which again result in a self-effecting shut-off once erosion is reached.

Those skilled in the art will further appreciate that the variability range of human anatomy is such that a ‘one size fits all’ is rarely comfortably achieved. By particular reference to FIG. 5 this limitation can be conveniently avoided by providing a conventional slip joint 111 in the straight portion of wand 11 such that its length can be conveniently adjusted by telescoping extension of the lower wand portion 11a out of the interior of an upper wand portion 11b. A conventional compression nut 112 engaged to the upper portion 11b can then be used to compress a resilient washer 113 to fix the extension of portion 11a once the desired length is selected.

In this manner a low effort, comfortable water stream sweeping assembly is conveniently obtained by adjustably combining a plurality of conventional mechanisms which need only limited modification. In each instance, however, ground eroding angles are avoided both by the geometry of the inventive wand structure and also by the increasing counterbalancing weight of the unsupported segment of hose 20 that reduces the ground contact forces on the post end 31 as the handle 116, or 216 in the embodiment shown in FIG. 4b, is lifted. Of course, as this contact force is reduced so is the friction force limit, thereby limiting eroding stream alignments. These limiting geometric attributes in the vertical plane then render the task of horizontal sweeping convenient.

While it is well known that the body form of a person varies greatly, the foregoing geometric effects will be best appreciated by those skilled in the art by further reference to FIG. 2 where, for example, a typical male user that is about 5 foot 11 inches in height will suspend his palm comfortably at about 30 to 34 inches above the ground surface G when standing erect. With these dimensions a wand length of about 36 inches spanning between the post 30 and the control valve 15 and including the arcs of the receiving and emitting portions that result in a generally horizontal alignment of the nozzle 25 supported on a post 30 about 2 to 3 inches in length.

When, however, the control valve is lifted by about 6 inches, i.e., to a height of about 38 to 42 inches above ground the nozzle 25 begins to reach ground eroding stream alignments. But then, at this raised height a longer segment of hose 20 is lifted from the ground, resulting in a heavier suspended weight vector WV20-1 and an outward shift in the center of gravity shown as CG20-1, both adding to the turning moment around the control valve which eventually result in unloading the support post 30 and the associated perception of loss of control that follows. Of course, these dimensional effects vary with the size of the user and for that reason the above telescoping adjustment has been provided in the wand segment 11. In each instance, however, the inventive water stream sweeping assembly provides a comfortable, well controlled feel when properly used that is detectably disrupted at improper angles.

Obviously many modifications and variations of the instant invention can be effected without departing from the spirit of the teachings herein. It is therefore intended that the scope of the invention be determined solely by the claims that follow.

It is claimed:

1. A water stream sweeping assembly useful in aligning a water stream adjacent the ground surface that is to be swept by the stream, comprising:
an elongate tubular wand defined by a convolved arcuate receiving portion and a convolved arcuate emitting portion each enclosing a hollow interior and each joined to the corresponding ends of a hollow central tubular segment to form a common interior cavity therewith, the arcuate convolution of said receiving portion being coplanar but generally opposite to the arcuate convolution of said emitting portion;
a fluid flow control valve threadably engageable to a water conveying hose connected to the free end of said receiving portion, said valve including a control handle on the exterior thereof conformed for manual articulation;
a nozzle connected to the free end of said emitting portion; and
a support post affixed to said emitting portion and aligned generally orthogonally to the exteriorly convex surface thereof wherein the length dimensions of said support post and said receiving and emitting portions are selected to align said nozzle substantially parallel to said ground surface upon the grasping of said control handle of said valve by an erect person.

2. A water stream sweeping assembly according to claim 1, wherein:
said control handle is pivotally attached to said valve in an alignment receivable in the hand of said erect person.

3. A water stream sweeping assembly according to claim 2, wherein:
said wand and said support post are dimensioned such that the combined weight of said sweeping assembly supported by said support post is generally counterbalanced by the weight of the unsupported portion of said water conveying hose when said control handle is lifted by the erect person.

4. A water stream sweeping assembly according to claim 3, wherein:
said central tube segment is selectively adjustable in the length thereof.

5. A water stream sweeping assembly according to claim 1, wherein:
said control handle is deployed in an alignment receivable in the hand of said erect person to suspend said valve therefrom.

6. A water stream sweeping assembly according to claim 5, wherein:
said wand and said support post are dimensioned such that the combined weight of said sweeping assembly supported by said support post is generally counterbalanced by the weight of the unsupported portion of said water conveying hose when said control handle is lifted by the erect person.

7. A water stream sweeping assembly according to claim 6, wherein:
said central tube segment is selectively adjustable in the length thereof.

8. A water stream sweeping assembly according to claim 7, wherein:
said central tube segment includes telescoping portions.

9. A water stream sweeping assembly useful in conveying water from a flexible water hose into a water stream nozzle and aligning said nozzle to emit a sweeping stream adjacent the ground surface that is to be swept by the stream, comprising:
an elongate tubular wand denied by a convolved arcuate receiving portion and a convolved arcuate emitting portion each enclosing a hollow interior and each joined to the corresponding ends of a hollow central tubular segment to form a a generally S-shaped combination enclosing a common interior cavity therewith communicating into said nozzle engaged to the free end of said emitting portion, the arcuate convolution of said receiving portion being coplanar but generally opposite to the arcuate convolution of said emitting portion;
a fluid flow control valve engaged between said flexible hose and the free end of said receiving portion, said valve including a control handle on the exterior thereof conformed for manual articulation; and
a support post affixed to said emitting portion and aligned generally orthogonally to the exteriorly convex surface thereof wherein the length dimensions of said support post and said receiving and emitting portions are selected to align said nozzle substantially parallel to said ground surface upon the grasping of said control handle of said valve by an erect person.

10. A water stream sweeping assembly according to claim 9, wherein:
said control handle is pivotally attached to said valve in an alignment receivable in the hand of said erect person.

11. A water stream sweeping assembly according to claim 10, wherein:
said wand and said support post are dimensioned such that the combined weight of said sweeping assembly supported by said support post is generally counterbalanced by the weight of the unsupported portion of said water conveying hose when said control handle is lifted by the erect person.

12. A water stream sweeping assembly according to claim 11, wherein:
said central tube segment is selectively adjustable in the length thereof.
